(19) United States
(12) Patent Application Publication
(10) Pub. No.: US 2007/0073572 A1
(43) Pub. Date: Mar. 29, 2007

(54) Data collection and distribution system

(75) Inventors: Thomas McLaughlin, Croton on Hudson, NY (US); Julius S. Klepacz, Danbury, CT (US); Gail Ferguson, Mohegan Lake, NY (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(73) Assignee: THE Q LLC

(21) Appl. No.: 11/235,753

(22) Filed: Sep. 27, 2005

(51) Int. Cl. G06F 9/46

(52) U.S. Cl. 705/9

(57) ABSTRACT

A method and apparatus for dynamically managing workflow information factors (who, what, when and where) and systematically combining (binding) these factors to facilitate the efficient completion of various jobs, which may be independent or interrelated and may involve work being performed by any number of discreet business enterprises. The invention's data management model equitably distributes system-related responsibilities based upon a hierarchy of assigned roles within four logical management levels. System-level permissions within the invention are limited by either the assignment of permissions or the actual assigned role itself. All system roles receive automatic notification of assignments, whether it is to a new role, a job or a binding. The invention's design facilitates the management of activity reporting within essentially any type business, which may include day-to-day operational functions, project-like jobs and service-oriented jobs. The invention also employs a novel call-center agent methodology and a target-driven daily reporting scheme.

### FIELD OF THE INVENTION

This invention relates to workflow management systems and methods and, more specifically, relates to systems and methods for efficiently distributing tasks across a network of workers within any number of associated businesses (business communities) engaged in any kind of work using a database structure that can be accessed and populated by all participants of the system.

### BACKGROUND OF THE INVENTION

The need to ascertain, address, plan for, execute and verify work-related tasks in multifaceted business enterprises is more acute than ever. Today, in order to stay competitive, businesses must operate with a high level of efficiency. The need to effectively manage internal and related external business workflows, particularly those that relate to diverse geographic and functional operations, can only be met by a systematic workflow management scheme.

Over the years attempts have been made to increase the efficiency, accuracy, etc. of business workflow using various iterations of enterprise resource planning (“ERP”) systems and the like. Although these systems may be the answer to organizing information, they are extremely costly and often take years to implement and produce useful results. In addition, many new devices, such as PDAs and “intelligent” phones, tend to inhibit robust data entry, thus negatively impacting the critical information collection process. Unfortunately these solutions, and many others, may only address the symptoms and not the cause of flawed workflow management. The core problem is neither the organization nor the portability of information, but rather, whether the overall business information collection and flow processes are designed to guarantee sustained quality.

A properly designed solution should be totally generic and address the workflow management needs for any kind of work within essentially any industry. The fundamental aspect of this versatility must lie in the disciplined collection, clear organization and intuitive access to pre-defined key business information, namely, the “who, what, when and where” of the workflow.

Five quality factors must be present and coincide to achieve the needed “high-quality” information. Information collected must be standardized, complete, unbiased, timely and accurate (“SCUTA”). The real answer to ensuring and acquiring this high-quality information is an all-encompassing discipline, or process, that guides “submitters” to submit SCUTA information all of the time combined with a means for “reviewers” to ensure that the discipline is being diligently followed. The process must be intuitive, logical, intelligent, and easy to learn and use, available to all submitters and reviewers under all circumstances, and functional at all times.

One attempt at providing a workflow management system is disclosed in U.S. Pat. No. 6,618,730 to Poulter, et al. Poulter discloses a web-based system which includes a server having a centralized database of “deal” data and at least one client system which facilitates a method of uploading initial proposed deal data, notifying an underwriter of the uploaded proposal, uploading a workflow timeline for the proposed deal and notifying responsible persons that actions for tasks are due according to the timeline. However, Poulter does not permit all users of the system to access and input information into the system, which severally limits the scope of performance of the system.

U.S. Pat. No. RE38,633 to Srinivasan discloses a multi-project management system and process in which multiple outgoing messages are sent to work-group team members, who in turn report back through messages to a central database. The Srinivasan patent does not teach the use of a centralized database within which all users have access for viewing and data input purposes, therefore, restricting the benefits that can be realized by such a system.

Numerous other attempts to provide workflow efficiency systems are proposed in the art, none of which employ a centralized information collection database that provides a standardized means for users to easily build any number of custom repositories for internal and external job-related SCUTA business information that can then be accessed, viewed and managed by all users of the system on the basis of their roles and permissions and an automated means for all submitted information to be rigorously reviewed and approved on a predetermined set time schedule. Therefore, there exists a need for such a system and related operational methods.

To accomplish its primary purpose, the instant invention provides a carefully structured framework composed of expert services and proprietary technology designed to enable businesses to easily and rapidly create, verify, store, access and manipulate SCUTA level business information across internal and external work activity at a fraction of the cost of other approaches.

### BRIEF DESCRIPTION OF THE DRAWINGS

FIG. 1 is a block diagram representative of a preferred embodiment of a system implementation of the instant invention.

FIG. 2 is a flow diagram illustrating initial steps taken by first and second logical management level users of the system.

FIG. 3 is a flow diagram illustrating steps taken by logical management level two users to create bindings

FIG. 4 is a flow diagram illustrating steps taken by logical management level three users of the system of their assignment to bindings within job(s) and the assignment of logical management level four to the same bindings.

FIG. 5 is a flow diagram illustrating steps taken by logical management level four users to assign workers to bindings.

FIG. 6 is a flow diagram illustrating steps taken to report and approve periodic reports.

FIG. 7 is a flow diagram illustrating steps taken by call-center agents to handle service call incidents.

FIG. 8 is a flow diagram illustrating the function and use of checkpoints by the second and fourth logical management levels and the steps taken by call-center agents.

FIG. 9 is a representative user profile screen display.

FIG. 10 is a representative information spreadsheet screen display page for a planner.

FIG. 11 is a representative spreadsheet screen display page for a resource assistant.

FIG. 12 is a representative spreadsheet screen display page for a resource allocator.

FIG. 13 is a representative spreadsheet screen display page for a call-center agent's data entry.

FIG. 14 is a representative spreadsheet screen display page for dispatch service call tracking.

FIG. 15 is a representative spreadsheet screen display page for a daily report.

FIG. 16 is a representative spreadsheet screen display page for a supervisor.

FIGS. 17 and 18 are essentially a single checkpoint screen and together are a representative spreadsheet screen display page for a checkpoint.

### DETAILED DESCRIPTION OF THE INVENTION

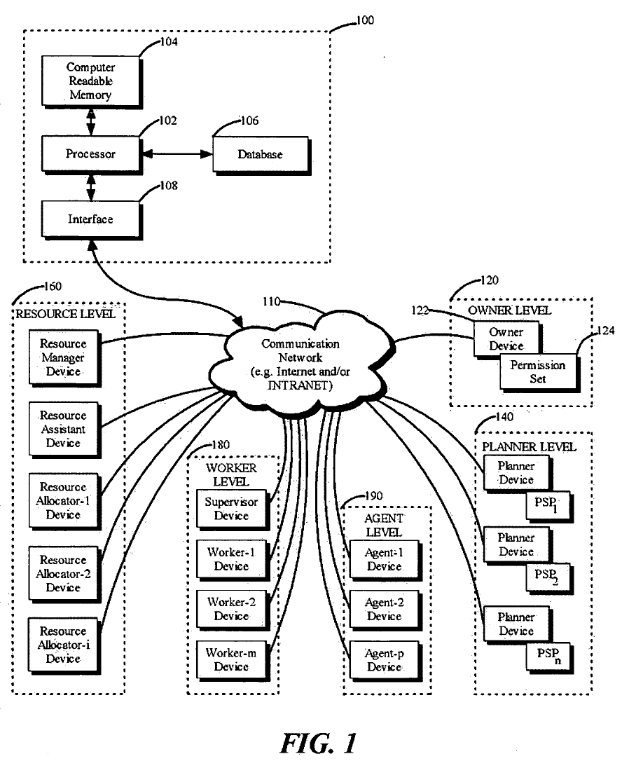

Generally, the present invention encompasses a method and apparatus for managing workflow factors to facilitate the completion of various jobs, which jobs may be independent or interrelated, to accomplish an overall objective. As illustrated in FIG. 1, the invention is preferably implemented as software running on a computer system.

The system includes a server 100 which in turn employs a processor 102, one or more memory devices 104, a database 106 for storing information relative to the various aspects of the tasks being carried out by the system, and an interface device 108 such as a modem or the like adapted to provide communication between server 100 and a communication network 110, (e.g., the Internet, an intranet, a local area network, or a wide area network).

The server 100 is accessible from various client devices (e.g., desktop computers, notebook computers, or personal digital assistants). In a preferred embodiment, the client devices may access the server 100 and utilize the workflow management software through use of their respective Internet browsers.

Based upon a logical hierarchy of roles, the invention's data management model equitably distributes system-related responsibilities across assigned roles. For example, the initial planning function could be viewed as a large bucket filled with the broadest aspects of (information about) a job. Each subsequent role in the job creation/completion process deals with more defined information and, at each role juncture, or level, the buckets of information become smaller and more numerous resulting in the distribution of responsibilities across a growing number of engaged users. Across the entire system, from the planner function (broad information and single large bucket) to the worker function (specific information and many smaller buckets), the present invention's distribution model ensures that all responsibilities are clearly defined and the execution of the tasks remain readily manageable. Data management is then preferably distributed across all logical hierarchical levels.

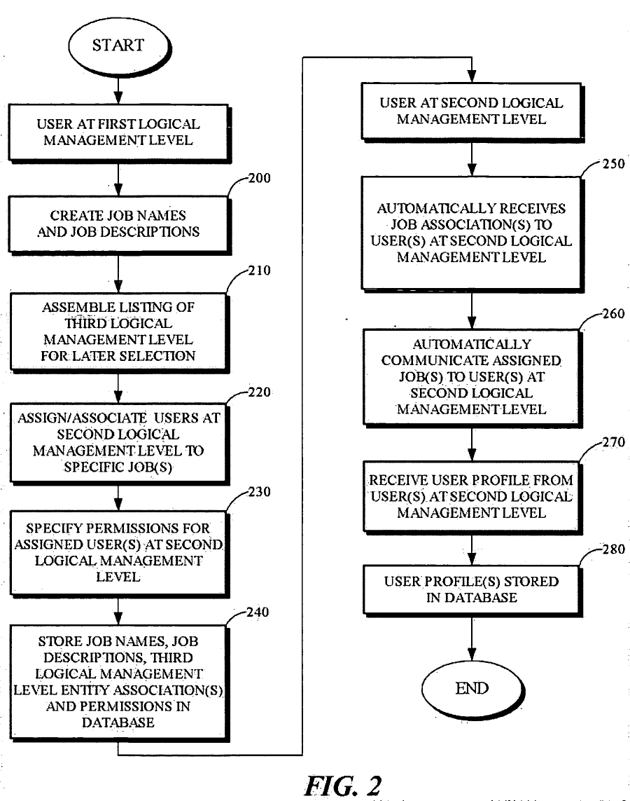

Much like players on a sports team, every system user is fully engaged in the workflow process and responsible for fulfilling the requirements of their own role/position, resulting in true collaboration. For example, each individual planner is assigned a permission set relative to his/her assignment to a specific job(s) in FIG. 2—230. All other users have specific guidelines for his/her area(s) of responsibility based upon assigned roles within jobs and each supplies their own individual information directly instead of through a central administrator or any of the higher levels of the logical management hierarchy. Thus, none of the logical management levels need to invest time fulfilling the responsibility of other roles, such as entering detailed role-related information for individuals or entities involved in using the system.

More importantly, the present invention is not limited to information collection requirements for only the individuals within a single business enterprise but rather accommodates the needs of a modern inter-related business community. In the course of doing business, a business enterprise may interface with any number of other business entities. All of these related entities readily participate in the system and process of the present invention.

For example, consider a job in which a financial institution, or other type of company, opens one or more new branches. All of the companies engaged in the new rollout effort, such as sign companies, electrical contractors, carpet layers, the bank's internal staff and others, can be assigned and report activities through a single standard process resulting in huge reporting and coordination benefits.

Another example could be a service company, providing services across a vast geographic area, requiring the support of any number of sub-contractors. All activity reporting would be handled by a single standardized process resulting in huge reporting efficiencies and streamlined administrative functions based upon the global standardization of all service-related information collection and reporting.

In accordance with the preferred workflow management process, and as best seen in FIGS. 1 and 2, a user at a first or primary logical management level 120 (e.g., a job or project owner, or “owner”, such as an executive or high level manager), is the default planner at job creation time with full permissions 124 (e.g. to view, add, modify, and delete), and has exclusive responsibility for (1) the creation and specification of overall job names and descriptions as seen in FIG. 2 at step 200, (2) the designation of global work entities (such as internal work groups, and external consultants or vendors, all being referenced herein as “resources”) at step 210 to fulfill work assignments across all jobs, (3) the assignment of second logical management level users (“planners”) to a job(s) at step 220, (4) the assignment of planner permissions within a job(s) at step 230, and (5) participating in data management of any created jobs along with assigned planners. These responsibilities are embodied in a “permission set” 124 possessed by the owner.

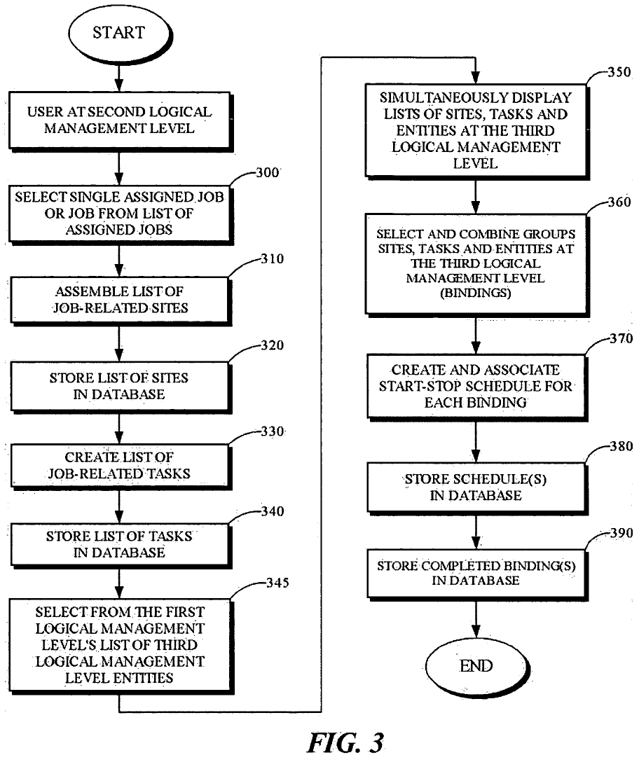

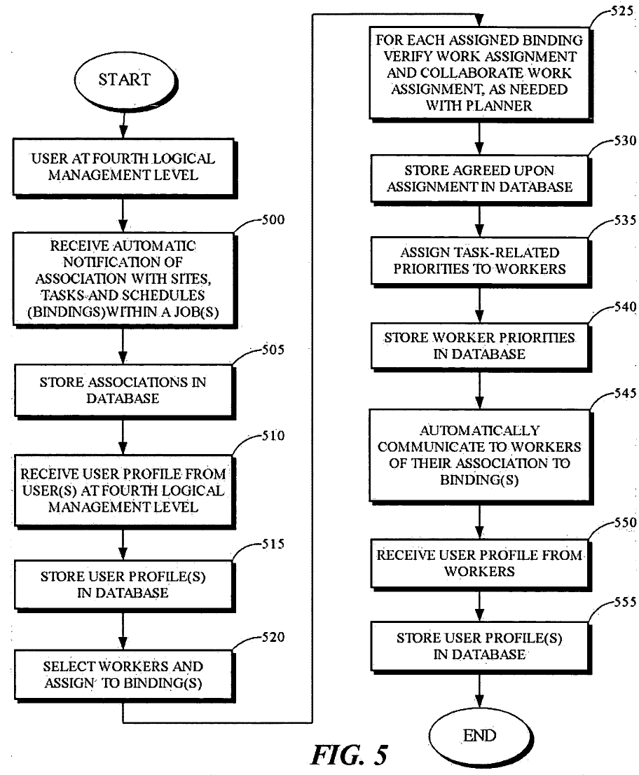

One or more users at a second logical management level at step 140, with the assignment as a planner(s), cause the compilation and selection of sites in FIG. 3—310, tasks at step 330 and resources at step 345 which make up a finite aspect of a job, referred to herein as a “binding” at step 360. For “project” type work, planners then attach a schedule at step 370 to each binding (completing binding: where, what, who and now when) for later collaboration with the assigned resource in FIG. 5—525. The planners access the server 100 through the communication network at step 110 using planner devices 1 through n, each planner having a customized set of permissions PSP₁ through PSPₙ in FIG. 1—140

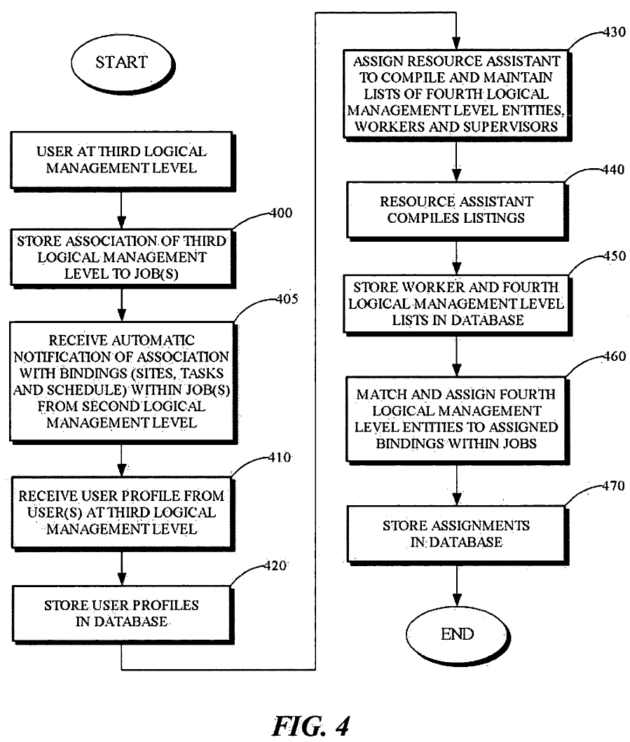

An automatic notification of each assigned binding(s) in FIG. 4—405 is sent to the individuals or entities known as the resource managers at the third logical management level at step 160. Resource managers act as the primary contact for a resource entity.

The resource manager does not necessarily oversee the services rendered and does not have permissions similar to the planner but rather full access to all jobs assigned to the resource limited only by which bindings (site and tasks) that the planner has bound the resource to within a particular job(s) at step 220.

The resource manager in turn assigns a resource assistant(s) in FIG. 4—430 to compile and maintain a master list of resource allocators and workers, and their related supervisors, at step 440. From this master list the resource manager selects and associates resource allocators to assigned bindings within each job(s) at step 460. Resource allocators receive automatic notification of their assignment to each binding in FIG. 5—500 and then associate workers at step 520 to the bindings based upon the site and task parameters. Workers receive automatic notification of their assignment to bindings at step 545 . . . The worker level at step 180 accesses the server at step 110 using worker devices 1 through m.

In general, the owner creates jobs in FIG. 2—200 and sets up a master list of resources at step 210. The planners then select resources from the master list created by the owner at step 345 and assign resources to particular jobs at step 360 based upon the set of permissions assigned to the particular planner by the owner in FIG. 2—230. For project-like jobs, the resource allocator(s) for each resource collaborate with planner(s) relative to the scheduling of tasks in FIG. 5—525. The resource allocators assign workers to particular bindings by choosing from a list of workers assembled by a resource assistant at step 520. The resource assistant plays a role similar to that of a human resources department, in that the resource assistant creates and maintains a list of all resource allocators and workers, along with their associated supervisors, at step 430.

The bindings can be thought of as three main “buckets” or collections of information: (1) resources, which are selected by the planner from the master list of resources at step 345 created by the owner at step 210, (2) tasks, which the planner develops and enters into the system at steps 330 and 340, and (3) sites, which the planner develops and enters into the system at steps 310 and 320. The association, or connection, of all three of these elements, “resources”, “tasks”, and “sites”, constitutes a binding. Once bindings are assembled by a planner(s) at step 360 and, in the case of “project”-like jobs scheduled at step 370, the resource manager is automatically notified of the assignment(s) at step 405 and can then assign resource allocators to individual bindings at step 460.

In the preferred embodiment, the planner (the second logical management level at step 140) to job association at step 220 is made, as shown in FIG. 2, by the owner simply entering an email address associated with the planning entity or individual Planner₁, Planner₂ . . . Plannerₙ. The association(s) is then stored at step 240 in the database 106. Planners can only access and view their own assigned jobs, and jobs in which they are co-joined with other planners, but not jobs associated with other planners assigned to different jobs.

In making the association(s) of jobs to planners, the owner preferably assigns and limits the database access permissions or privileges of each planner at step 230 such that the planner can only control (e.g., add, modify and delete) its assigned jobs to the extent allowed. All planners associated with a particular job preferably have “view” permissions for the assigned jobs. The owner retains database access permissions sufficient to control any and all planner associations within all of that owner's jobs.

Permissions for planners may sometimes herein be referred to as “permission sets”, and may be, and usually are, customized. For example, Planner₁ may have a permission set PSP₁, Planner₂ a permission set PSP₂ which may be different, or may be the same, depending upon the needs of the situation, as permission set PSP₁, and so on through Plannerₙ, with permission set PSPₙ.

The permission set concept as presented only applies to the planners. Resource managers, resource allocators, resource assistants and workers do not have permissions in the same sense but rather permissions based upon their roles and, in the case of the resource manager and resource allocator, the assigned jobs and bindings within the job(s). Workers' permissions include filling out daily reports and profile information as well as viewing assigned dispatch and checkpoint screens.

As seen in FIG. 2, in the preferred embodiment, after the owner has entered the associations of planners with their respective jobs at step 220, the server software automatically sends an email message at step 250 via the communication network at step 110 to the planner's email address, entered by the owner, advising the planner of his/her association to that job(s). The email also preferably includes a hyperlink to the server and a temporary password to enable the planner to use his/her browser to access the database at step 106, whereupon the planner is prompted to enter a user profile at step 270. The database stores that profile at step 280. Upon accessing the database, and depending upon database access permissions for a particular assigned job, the planner may be enabled to add, modify, delete or just view information stored in the database.

After receiving his/her email notification, the planner accesses the server at step 100 via the communication network at step 110 to receive (e.g., view) the association of jobs submitted by the owner to the planner at step 220. The planner is preferably provided with the information and the functionality (i.e. permission) at step 230 to readily assemble or combine a resource (who), a task (what) and a site (where), into a structure referred to as a “binding” at step 360. The purpose of the binding process is to allow the planner to define assignable segments of work in their most fundamental form. For project-like jobs, after each binding is created, the planner enters a specific start and stop time at step 370 (when) for each binding for later scheduling collaboration with each resource at step 525.

The planner can then create tasks at step 330 needed to fulfill the requirements of the job (e.g.: what is to be done) and compiles a list of sites at step 310 (e.g.: where the task(s) is to be performed) and select resources (who is to perform the task) from the list of resources that the owner has already specified at step 345. The planner then associates each task with a site and a resource at step 350 to create a binding at step 360. In a preferred embodiment, after the planner logs onto the server at step 100, the software displays at step 350 a list of sites, tasks and resources (i.e.: entities/persons at a third logical management level) to the planner. To create bindings within a job at step 360 the planner uses these listings of tasks, sites and resources.

As shown in FIG. 4, once a task, site and resource have been associated at step 360 as a binding within a particular job, that binding is stored in the database (at step 106) at step 390, the system preferably sends an email at step 405 to the respective third logical management level at step 160, or “resource manager” (the primary point of contact for each resource), notifying that resource manager of the resource being associated to the job(s) at step 405. The system then prompts the resource manager (user at the third logical management level) to provide a user profile at step 410, which profile is stored in database (at step 106) at step 420.

Once notified of the association with a binding, the resource manager preferably selects an individual or business entity to perform a “resource assistant” role at step 430, that of maintaining a current combined listing of workers, along with their associated supervisors, and fourth logical management level at step 160, entities known as “resource allocators.” The resource manager then assigns a resource allocator(s) to one or more of the binding(s) (sites and tasks) at step 460 to which the resource is associated within each job. The resource allocator is automatically notified of the association at step 500, from the server transmitted over the communications network at step 110. The resource allocator then enters his/her user profile at step 510 which profile is stored in database (at step 106) at step 515.

In the preferred embodiment for project-like jobs, resource allocators are then responsible to collaborate with the assigning planner(s) at step 525 relative to the work schedule of each assigned binding stored in the database at step 106. The system preferably provides a display of the specifics (e.g. site, task and start/stop schedule for project-type jobs) for each resource assignment at step 350. Each resource allocator can only view his/her assigned association(s) within the job. In the event of a discrepancy relative to the assigned schedule, the system preferably provides the means for the resource allocator to collaborate back and forth with the planner(s) relative to modifying the schedule to meet specific requirements that may impinge upon the specifics of the binding at step 525. The system stores the agreed-to schedule and the association(s) in the database (at step 106) at step 530.

As shown in FIG. 3, should a job require the involvement of multiple resources, the planner may then select from a list at step 345 the desired “resources”, or business entities or work teams, to be assigned to each binding at step 360. As shown in FIG. 4, once each resource is selected, the respective resource manager is notified via email at step 400 of the resource's assignment to the job enabling each additional resource manager to assign resource allocators to the assigned bindings at step 460 for collaboration with the planner(s) relative to scheduling at step 525. As show in FIG. 5, the resource allocator at step 160 (fourth logical management level) is then responsible for the assignment of workers at step 520 to accomplish the task at the site specified in each binding at steps 320 and 340. This additional association is stored in the database at step 530. Similarly, the resource allocator need only select the preferred worker(s) for each site or set of sites and each task or set of tasks to be performed from the resource assistant's list at step 520. The email address (user name) of the worker may, in one embodiment, be selected from the resource assistant's list of user names at step 450. Once a worker association has been made at step 520, the worker is notified of the association at step 545, preferably by receipt of an automatically generated email sent from the server at step 100. The worker then inputs his/her user profile at step 550, which is stored in database (at step 106) at step 555.

The association of the worker to bindings may also include, at step 520, a prioritization of the workers to be stored in the database (at step 106) at step 540. For example, when two or more workers are capable of completing a task at the site specified in a binding, all such workers may be associated with the binding and be given relative priorities. In such a case, each worker is preferably assigned a priority with respect to the task within the binding. An exemplary priority schedule, in ranked order, may include primary, secondary, tertiary and ordinary levels of priority. Thus, the worker best suited to complete the task or assigned to the particular area or territory would be identified as primary and the worker least suited, but still capable, may be identified as ordinary. The priorities may be based on many factors, including the worker's performance capabilities, training, certifications and availability, just to name a few. Each worker is then automatically notified of his/her priority and association with assigned bindings at step 545.

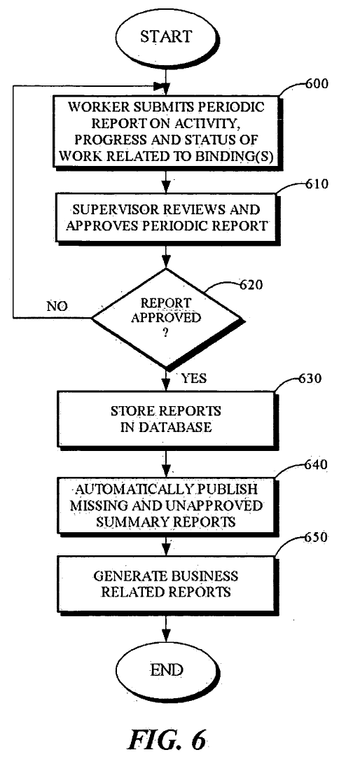

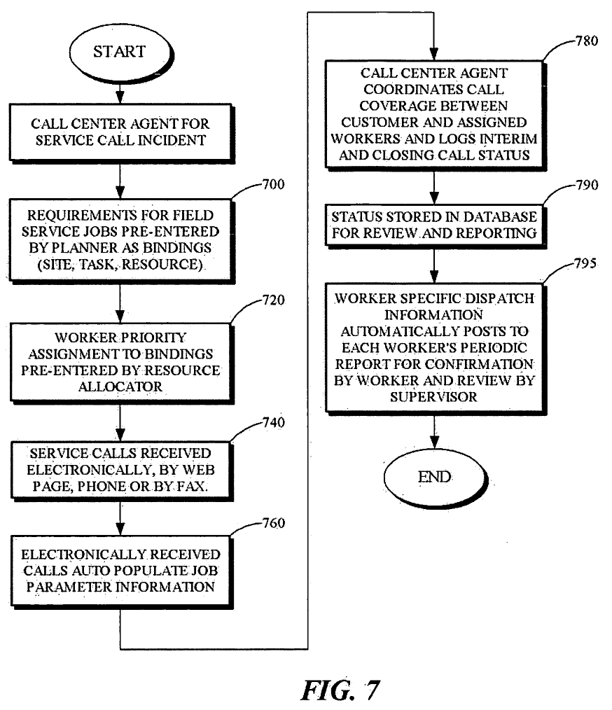

To monitor worker progress and account for time expended on the tasks, each worker logs into the server using his/her user ID and password via the Internet and then prepares and submits a daily or other periodic report at step 600 in FIG. 6. In its preferred embodiment, all of the site and task information to be used by the worker in the periodic report has already been entered into the database by the owner or planner(s) and integrated into the binding(s) for that specific job at step 360. This ensures that all of the information that is needed by the worker is included, but no more. The worker simply selects the required information using a “point and click” modality virtually eliminating data entry errors relative to the input of information. The report is generated at step 600, reviewed at step 610, approved at step 620 and stored on the server at step 630.

It is important to note that the supervisor is a role that is entered by the resource assistant at the same time as the worker role in FIG. 4, step 430. A requirement in the entry of each worker in the resource assistant list is the assignment of an associated supervisor to review and approve periodic reports at step 610.

As with all other roles in the invention, the supervisor is automatically notified of the association with a worker(s). In the event that the supervisor has not already been assigned another role, the supervisor, when initially logging into the system, must enter his/her user profile to be stored in database at step 106.

Preferably, “full reporting” is enabled by the invention. For example, if the entered time duration is less than a full eight-hour workday, the system automatically disallows acceptance and the worker must then select and enter additional tasks until the worker's time accounts for at least the predetermined minimum time requirement. The report form also preferably includes a text box in that the worker can enter any problems encountered in preparing the report.

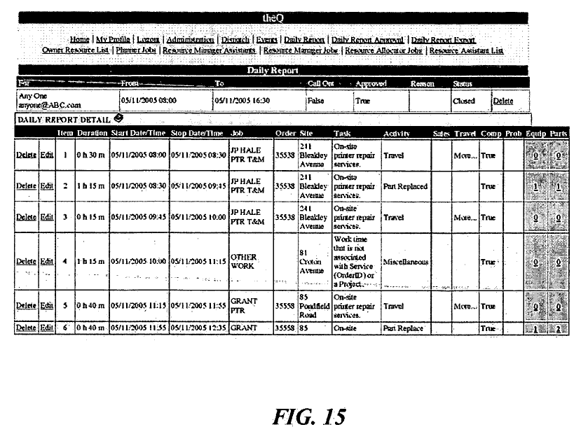

After the worker prepares and submits a periodic report at step 600, the report is queued for review at step 610 and approval by the worker's supervisor at step 620. The supervisor is, preferably, the worker's manager, who is to review the worker's periodic reports and approve or reject them. Approval, if so provided, is entered at the server and stored in the database at step 630. If the supervisor rejects the report at step 620, the supervisor provides a basis for the rejection or refusal in the report and the worker is automatically notified of the refusal by electronic mail or another appropriate manner. The worker can then access the database using his/her login information, correct the report, and resubmit the periodic report at step 600. Such would be the case in the event that the worker indicated a problem in preparing a report. A representative example of such a report is shown in FIG. 15.

While a daily report has been described above, one of ordinary skill in the art will readily recognize that a report covering any other period of time (e.g., weekly, monthly, and so forth) or which includes additional or other information may alternatively be used and be deemed to be within the general scope of the present invention.

An important aspect of the invention is that, at a predetermined frequency, the system uses an automation process to publish summary reports to a predetermined list of system participants indicating those reports (by worker) that are missing (not submitted by a specific deadline) and those reports (by supervisor) that have not been approved, again by a specific deadline at step 640.

The use of a pre-formed periodic report, such as the daily report discussed above, combined with the system-monitored timely review and approval of a supervisor, the requirement that all periodic reports must be submitted and approved within a clearly communicated timeframe, and that all violations of the reporting and approval time limits are generally published to a predetermined list of system users at step 640, imposes the business discipline needed to ensure standardized, complete, unbiased, timely, and accurate (SCUTA) reporting of needed business information.

The foregoing description focused its attention primarily on jobs that may require special advanced time-line planning and detailed management, such as product development and/or manufacturing or new or renovated business location rollouts. However, the present invention is applicable to essentially all forms of business management requirements, including standard time and attendance reporting, departmental and consultancy activity tracking, and client hourly reporting, to name a few.

In this regard, the management of field service-oriented jobs is an integral part of the invention, such as the real-time dispatch of workers in response to calls for remedial services. In the preferred embodiment, dispatching functionality can accommodate variable and complex business situations. Specific call-related information is entered into the appropriate fields either electronically at steps 740 and 760 or by a specially trained individual at step 740, referred to herein as a “call-center agent”, but limited to the requirements already entered in advance by planners relative to job bindings at step 700 and worker assignments entered by the resource allocators at step 720 and then stored on the server. All service call inflows are time stamped and clocked to the minute.

In the preferred embodiment for field service jobs, the customer telephones the call-center agent, but in alternative embodiments may contact the call-center agent via web page, FAX, email, or any other known means of communication, whereupon the system or the call-center agent will create a record of the communication from the customer and the call-center agent will respond by dispatching the appropriate worker using the system of this invention. To do so, the call-center agent will access server at step 100 using the communication network at step 110, and contact, or cause the system to contact, the appropriate worker at step 780.

Preferably, predetermined service call response requirements for each binding are also provided in advance by the planner(s). Upon the receipt of a service call, call-center agents contact workers who are assigned to the tasks within the related job at step 720 based upon the priority levels established in advance by the resource allocator at step 535.

A preferred embodiment of the dispatch functionality is that all of the service call information collected by the call-center agent is automatically reflected in the worker's periodic activity report. Key information is electronically passed through the system at step 100 to the periodic report interface at step 795. Each time a worker starts to enter information into his/her periodic report, the corresponding information that was entered by the call-center agent for that same date and timeframe is posted on the worker's report page for review and verification at step 795. The worker is also provided with a link back to the dispatch function enabling the worker to “drill down” for more information. When the worker submits the periodic report the corresponding dispatch information remains visible for review by the worker's supervisor for variances or conflicts also at step 795. The transmission of key information between the dispatch and reporting functions ensures that the information collected by the call-center agent is recognized as the basis for entering and verifying SCUTA information in the periodic report by each worker.

In addition, the worker cannot skip over any timeframe where service call information has already been entered by the call-center agent. The system automatically provides notice to “roll back” to the missed timeframe and disallows the entry of any subsequent time reporting until the skipped-over timeframe is accounted for in the worker's periodic report.

In business situations where workers are performing remote fieldwork, a significant portion of the worker's time may be spent traveling to and from assigned worksites. This is generally referred to as “windshield time” and often considered to be somewhat non-productive time relative to accomplishing assigned tasks. A preferred embodiment of the dispatch functionality takes advantage of the hands-free aspect of today's cell phones and the already collected task-related information that is readily available to the call-center agents attending to dispatch. During windshield time, or the worker's travel time in a bus, train or car, the worker contacts dispatch via cell phone and requests that the call-center agent collaborate with him/her relative to filling out the worker's periodic report and filling in the missing time gaps to ensure full reporting. The system automatically logs which worker activities the call-center agent fills out. At the end of the day the worker reviews the agent-entered information, completes the periodic report and submits it for approval. In those cases where a worker may be unable to access the Internet or intranet, the call-center agent, under the guidance of the worker, completes and submits the worker's periodic report for supervisor approval, again with the notification as to which Agent has done the worker's reporting. This feature of the invention allows the accomplishment of the worker's often time-consuming reporting requirement to be accomplished during travel time instead of at the end or beginning of the workday, or possibly on overtime.

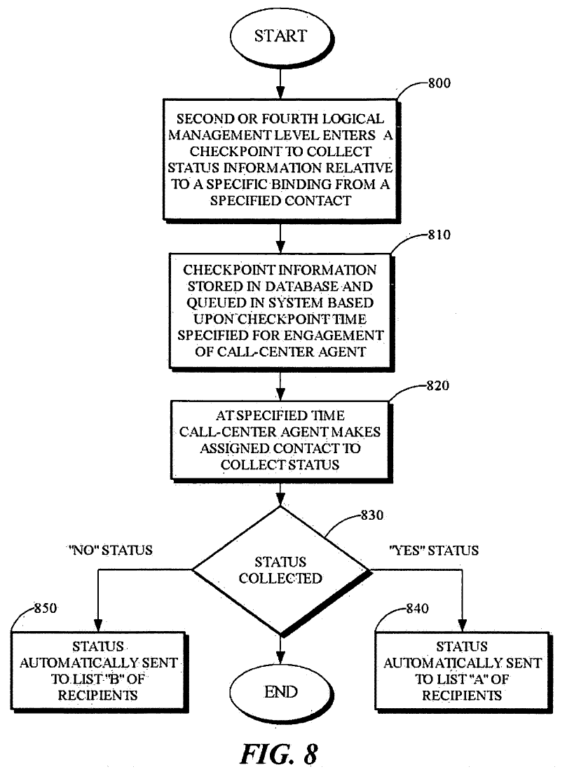

For jobs where dispatch-like functionality is not needed, such as routine work assignments and project-like work, the preferred embodiment of the invention provides the same level of robust planning and reporting but includes an additional function designed to proactively address certain workflow issues and problems. Relative to verifying the status of planned tasks, planners and resource allocators may develop checkpoints, or status questions at step 800 in FIG. 8. As an example, the planner at XYZ Company schedules a cable to be installed at One Main Street on Jul. 5^{th} at 11:00 AM by a worker from ABC Company. The resource allocator at ABC could create a checkpoint to verify in advance that the cable arrived (say on Jul. 4^{th} “Did the cable arrive?”) at step 800 so as to be sure the worker does not travel to the site needlessly. The planner at XYZ could create a checkpoint at 11 AM on Jul. 5^{th} to be sure that the worker showed up (Did the worker show up?) at step 800 or another checkpoint at 2 PM on Jul. 5^{th} to verify that the cable was installed (Was the cable installed?), again at step 800.

In the preferred embodiment, a checkpoint is associated with a particular binding within a job at step 800 in FIG. 8 and staged electronically in a queue at step 810 for a call-center agent to handle at step 820 in FIG. 8. At the time specified the checkpoint automatically appears in the call-center queue at step 820. The call-center agent contacts the designated party specified by either the planner or the resource allocator at step 820 to verify which status (yes or no) is related to the checkpoint question and to provide details, if necessary. The call-center agent collects and records the response at step 830 and the system automatically and electronically notifies the appropriate list of recipients at steps 840 or 850, specified in advance by the planner or resource allocator, with the possibility of two dissimilar lists of recipients based upon a yes or no status collected at step 830 to the “checkpoint status” question. It is important to note that planners and resource allocators can add one or more checkpoints related to a binding and target any recipient with an email address relative to the checkpoint status being collected, even recipients who do not have an active role in the system. The call-center agent is engaged in both break/fix service calls as well as checkpoints in project-like jobs (e.g. manufacturing and business relocation rollouts). In connection with break/fix service, the call-center agents inputs service requests from customers as well as service call activity and ongoing status information to be used for operational management and in conjunction with the workers' information input to their daily reports.

In the preferred embodiment, the customer telephones the call-center agent, but in alternative embodiments may contact the call-center electronically or by web page, FAX, email, or any other known means of communication, whereupon the system or call-center agent creates a record of the communication from the customer and the call-center agent dispatches the appropriate worker using the system of this invention. To do so, the call-center agent accesses server at step 100 using the communication network at step 110, and contacts or causes the system to contact the appropriate worker(s).

Therefore, as disclosed above, the present invention provides a hierarchical approach to workflow management in which each logical management level of the hierarchy is responsible for creating and managing certain associations. The present invention further provides a workflow management system in which there is no centralized entity responsible for inputting and updating contact and other related data for entities involved in a particular job. Instead, the present invention provides for localized data updating at each logical management level to insure prompt and accurate data management.

The present invention further provides each user with a “private” view of his/her specific workspace based entirely upon the assigned roles within each job. For example, a resource manager assigned to bindings within a job is only able to view those bindings but not the bindings of other resource managers that may be assigned bindings within the same job in FIG. 4—405. Each worker's periodic report will only enable the selection of the specific sites and tasks (and activities as a subset of tasks) for a particular job as previously established by the planner during the creation of the bindings (site, task and resource) in FIG. 6—600.

The present invention further provides for the timely and accurate capture and accounting of the day-to-day activities of workers engaged in various tasks within a job by requiring time-contiguous activity entries in daily or other periodic reports prepared by workers. Still further, the present invention ensures submission of relevant and accurate activity data by limiting daily report entries to certain pre-established information and preferably requiring supervisor approval at step 610 prior to acceptance and inclusion in business reporting requirements for business related reports, such as billing statements, payroll records, expense reporting and the like, at step 650.

The four logical management levels (owner, planner, resource manager and resource allocator) may be implemented by a single individual or entity for simple jobs or smaller companies. For complex jobs, separate individuals and/or entities may be required to implement the various logical management levels. Thus, the present application provides a scalable workflow management solution regardless of the job size.

Moreover, since the present invention is preferably web-based, a single database can provide management support services for a multitude of different jobs, without requiring each separate business entity involved to separately acquire the hardware and software to implement the management system. Rather, in such cases, the entities may obtain access to the server through payment of a subscription or through their involvement in a job in which the owner is provided appropriate consideration for use of the workflow management system.

Many workflow software applications provide for business planning of task contingencies and task-related dependencies. There is, however, a wide gap between the functionality of these solutions and the need for an easy to use means to address the reality of day-to-day workflow dynamics. The implementation of the present invention, through its “checkpoint” interface, allows planners and work staff leaders (resource allocators) to readily collect the status of specific tasks and receive and distribute timely feedback information to predetermined lists of recipients in FIG. 8—840 and 850.

The combination of (1) the point and click modality, limiting reported information to a predetermined set of required information, (2) the automatic transmission of key dispatch information to the periodic report interface, (3) the required reconciliation and supervisor review, and (4) the publishing of missed submission timing requirements for periodic reporting and supervisory review, ensures the discipline needed for ongoing SCUTA-level reporting.

Since the system of this invention is web-based with the entire application housed within one server site in FIG. 1—100, none of the users of the system need special software or hardware to utilize the system and, therefore, modifications and updates are immediately made available to all users of the system. At the same time, “view” permissions enjoyed by all users of the system permit users of the system at any time to review the status of the project to which they have been associated so that real-time status information is available to all users.

In the final analysis, and in the preferred embodiment, it is the inherent design of the invention that ensures the delivery of SCUTA-level information to be readily available all of the time.

The “S”, or standardized aspect, is delivered based upon the universality of the invention. This is accomplished through the invention's versatility in addressing the need for a single standardized approach to collecting information related to the activities for an unlimited range of business applications, from basic employee time and attendance reporting to internal and external project-like jobs to service-related dispatched jobs. Most important, this universality extends well beyond the need for information from a single core enterprise, but may encompass virtually any number of other outside individuals and/or enterprises that may be engaged within the context of diverse geographic and multi-functional jobs, thus forming a business community, all reporting being based upon one standard methodology within the context of one system.

The “T, C and A” aspects of SCUTA, or the timeliness, completeness and accuracy of collected information are addressed through the rigorous and robust nature of the dispatch, periodic report, supervisor review and checkpoint functionality of the system.

It is the “U”, or unbiased nature of the SCUTA standard that is worthy of additional discussion. The invention is designed to facilitate business communities, both internally (e.g.: between divisions, work groups, etc.) and externally, thus enabling the broad delivery of unbiased information through the “views” intentionally provided to certain roles within the system. For example, an owner, or planner, can view all of the information delivered within an assigned job, including the information input by any and all roles, and from all resources, across the entire job(s). The planner's view includes access to view daily report activities, dispatch information and checkpoint entries for all roles engaged within a job(s). The same level of expansive view applies to resource managers and resource allocators within their assigned bindings within a job(s). In addition, other entities may be designated as users with a “view”, limited only by the level of the job(s) assignment. The key point is that all information is exposed and can be broadly scrutinized by direct management within a particular company or authorized individuals from outside of that company, such as owners and planners from a contracting business entity.

In addition, given the fact that the dispatch function resides essentially outside of all business entities engaged in the invention, including the owner roles, the collection and dissemination of information by dispatch is autonomous. This level of information visibility and non-exclusivity (dispatch) contributes heavily to ensuring that the information being collected and distributed is unbiased.

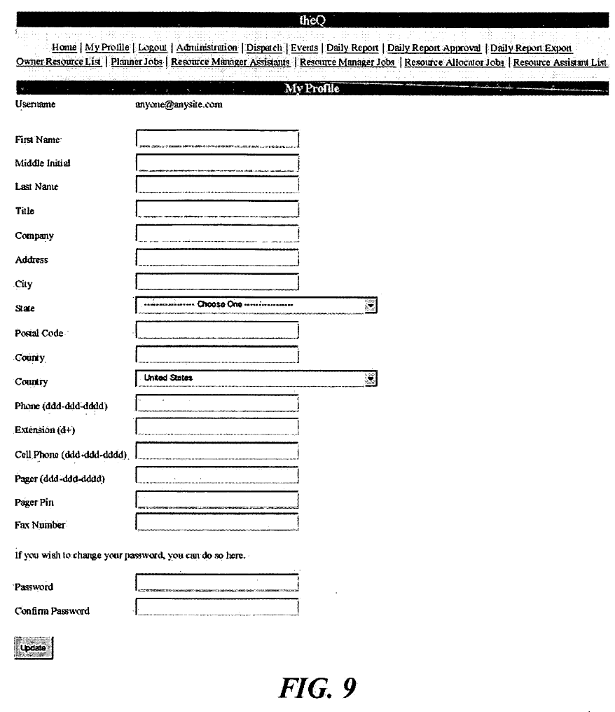

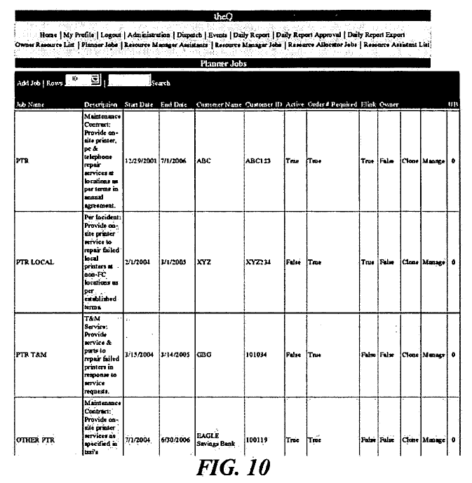

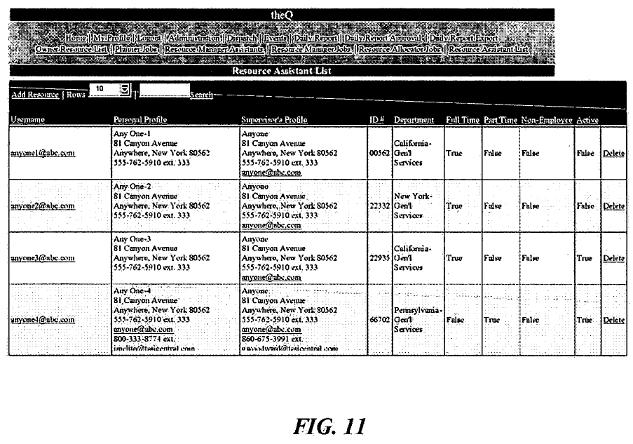

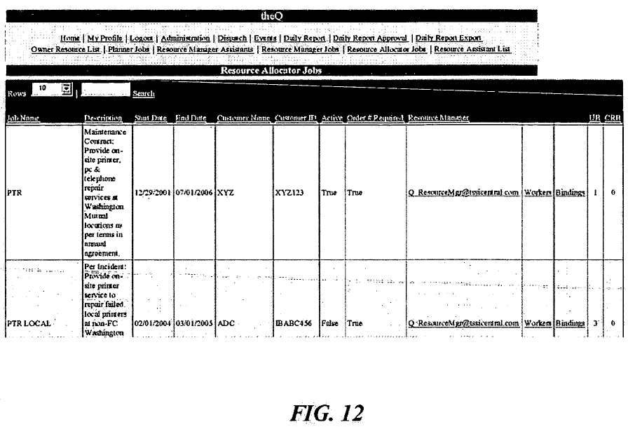

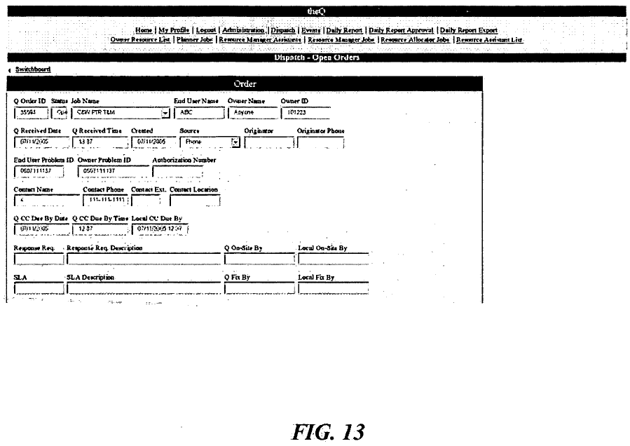

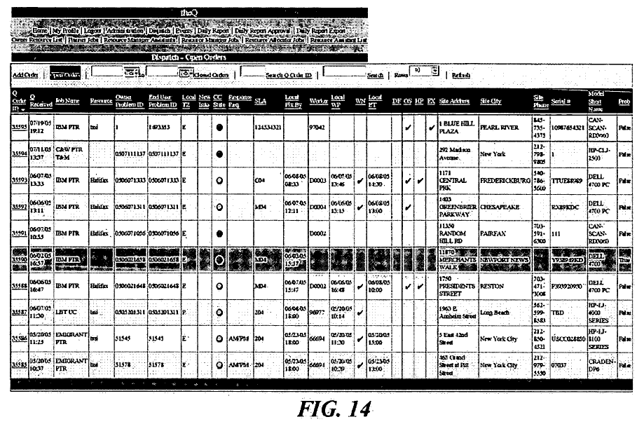

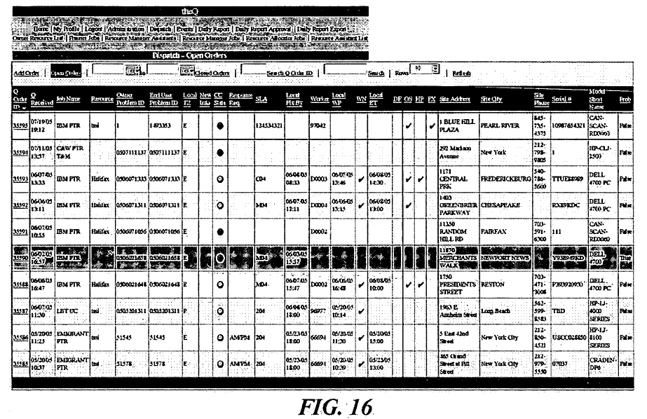

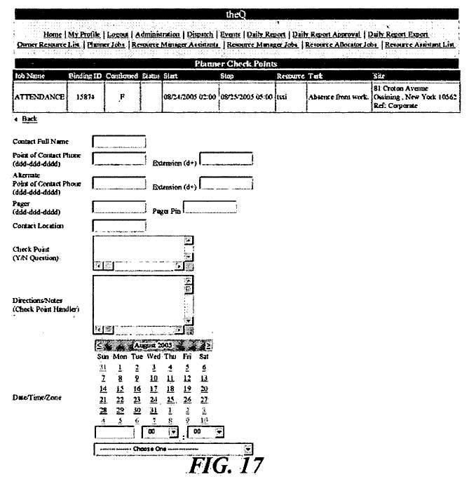

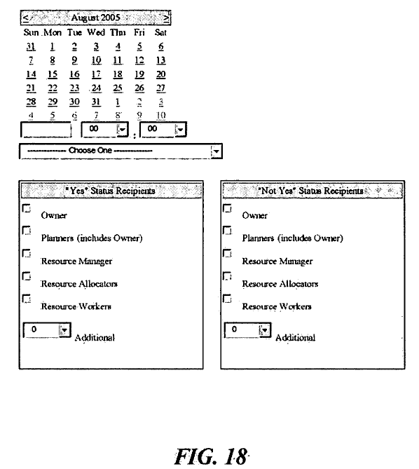

Regarding FIGS. 9 through 18, in using the system and referenced throughout this application, at each level the system provides a universal profile entry page for all system users at all levels, with the system display screen illustrated in FIG. 9., FIG. 10 is a representation of planner jobs assigned to a planner by an owner. A screen shot of a resource assistant list is shown in FIG. 11. A number of fundamental parameters relating to jobs assigned to a resource are presented in FIG. 12., FIG. 13 represents a data entry screen to be used by a call-center agent for called-in service calls. The same information may also be automatically populated through an electronic link or from a web page. FIG. 14 provides a view of the call-center agent's switchboard-like screen providing status on any number of open (or closed if so chosen) service calls. FIG. 15 illustrates a portion of a daily report showing a number of activities entered by a worker for particular time periods within a single day. FIG. 16 shows a supervisor's view of another daily report wherein there is information that has been passed through electronically from dispatch thus providing the means to cross-check the unbiased information previously entered by an agent(s) and now showing in the daily report interface. The worker is thus required to account for the prior dispatch entries in terms of content and timeframes, FIGS. 17 and 18 represent one checkpoint entry screen for a planner. A resource allocator would use a similar screen. All system users who are assigned in any way to a binding that has a checkpoint(s) would have view privileges to that checkpoint. Only the checkpoint author can make any changes to a checkpoint and then only prior to being activated within the dispatch queue.

What is claimed is:

1. A method for hierarchically managing workflow to facilitate completion of a plurality of jobs, each job comprised of a plurality of tasks, the method comprised of:
receiving, from a user at a first logical management level of a hierarchy of logical management levels, a listing of workgroups to whom responsibility for the completion of tasks associated with a particular job may be assigned;
receiving a first association of a job with a second logical management level of the hierarchy to produce a first association, the first logical management level being associated with a first set of database access permissions that are broader than a second set of database access permissions associated with the second logical management level;
storing the first association in a database such that control of the first association requires the first set of database access permissions; and
responsive to storage of the first association in the database, automatically communicating information relating to the first association to the second logical management level of the hierarchy the information at least notifying the second logical management level of the hierarchy that the first association has been made.

2. The method of claim 1, wherein the step of automatically communicating information relating to the first association comprises automatically generating and sending an electronic mail message to an email address associated with the second logical management level of the hierarchy.

3. The method of claim 2, wherein the second logical management level of the hierarchy is identified in the database solely by the email address.

4. The method of claim 2, wherein the email address is a group email address associated with a group of users at the second logical management level of the hierarchy.

5. The method of claim 1, wherein the information relating to the first association comprises at least a hyperlink to a server at which the database is maintained.

6. The method of claim 5, wherein the information relating to the first association further comprises a temporary password to access the server.

7. The method of claim 1, further comprising:
receiving, from a user at the second logical management level of the hierarchy a user profile that includes at least one of an identity of the user, a company affiliation of the user, contact information for the user, and a permanent password for use in accessing the server; and storing the user profile in the database.

8. The method of claim 1, wherein the second logical management level of the hierarchy is responsible for assigning a site or sites to the job at which the plurality of tasks are to be completed.

9. The method of claim 1, wherein the second logical management level of the hierarchy is responsible for assigning a task or tasks to the job.

10. The method of claim 1, wherein the second logical management level of the hierarchy is responsible for selecting and assigning a resource(s) to a job from a listing of resources previously entered by the first logical management level.

11. The method of claim 1, wherein the second logical management level of the hierarchy is responsible for assigning a schedule or schedules to the tasks within a job.

12. The method of claim 1, wherein at least one of the jobs further includes a plurality of sites at which a plurality of tasks is to be completed.

13. The method of claim 1, further comprising:
receiving, from a user at the second logical management level of the hierarchy, a second association of a first group of the plurality of tasks, a first group of a plurality of sites, a resource and a first group of a plurality of schedules with a third logical management level of the hierarchy, an individual within the third logical management level being the primary contact for the resource assigned to complete the first group of tasks;
the association of the first group of the plurality of tasks and the first group of the plurality of sites with the resource being referred to as a binding;
storing the second association in the database such that control of the second association requires at least one of the second set of database access permissions and the first set of database access permissions; and
responsive to storage of the second association in the database, automatically communicating information relating to the second association to the third logical management level of the hierarchy, the information at least notifying the third logical management level of the hierarchy that the second association has been made.

14. The method of claim 13, wherein the step of automatically communicating information relating to the second association comprises automatically generating and sending an electronic mail message to an email address associated with the third logical management level of the hierarchy.

15. The method of claim 13, wherein the email address is a group email address associated with a group of users at the third logical management level of the hierarchy.

16. The method of claim 13, wherein the third logical management level of the hierarchy is identified in the database solely by the email address.

17. The method of claim 13, wherein the information relating to the second association comprises at least a hyperlink to a server at which the database is maintained.

18. The method of claim 17, wherein the information relating to the second association further comprises a temporary password to access the server.

19. The method of claim 13, further comprising:
receiving, from a user at the third logical management level of the hierarchy, a user profile that includes at least one of an identity of the user, a company affiliation of the user, contact information for the user, and a permanent password for use in accessing the server; and storing the user profile in the database.

20. The method of claim 13, wherein the step of receiving an association of the first group of the plurality of tasks and the first group of the plurality of sites and the first group of the plurality of schedules with a resource-related to the third logical management level of the hierarchy comprises:
displaying a list of resources, with resource-related contact entities, functioning at the third logical management level of the hierarchy, the list of entities having been pre-established by the user at the first logical management level of the hierarchy; and
receiving, from the user at the second logical management level of the hierarchy, selection of at least one entity with its contact functioning at the third logical management level of the hierarchy to produce the association of the first group of the plurality of tasks and the first group of the plurality of sites and the first group of the plurality of schedules and the resource with the third logical management level of the hierarchy.

21. The method of claim 1, wherein the list of resources functioning at the third logical management level of the hierarchy comprises a listing containing identities of the entities.

22. The method of claim 13, wherein the step of receiving an association of the first group of the plurality of tasks and the first group of the plurality of sites and the first group of the plurality of schedules with the third logical management level of the hierarchy comprises:
displaying a listing of the plurality of tasks, the listing of tasks having been pre-established by the user at the second logical management level of the hierarchy; and
displaying a listing of the plurality of sites, the listing of sites having been pre-established by the user at the second logical management level of the hierarchy; and
displaying a listing of the plurality of schedules, the listing of schedules having been pre-established by the user at the second logical management level of the hierarchy; and
receiving, from the user at the second logical management level of the hierarchy, selection of the first group of tasks from the listing of tasks and the first group of sites from the listing of sites and the first group of schedules from the listing of schedules to produce the association of the first group of the plurality of tasks and the first group of the plurality of sites from the listing of sites and the first group of the plurality of schedules from the listing of schedules with the third logical management level of the hierarchy.

23. The method of claim 13, further comprising:
receiving, from a user at the third logical management level of the hierarchy, a third association of a first group of the plurality of tasks, the first group of the plurality of sites, a resource, and a first group of the plurality of schedules with a fourth logical management level coordinating the scheduling and assigning of workers to the first group of tasks at the first group of sites;
storing the third association in the database such that control of the third association requires at least one of the second set of database access permissions and the first set of database access permissions; and
responsive to storage of the third association in the database, automatically communicating information relating to the third association to the fourth logical management level of the hierarchy, the information at least notifying the fourth logical management level of the hierarchy that the third association has been made.

24. The method of claim 23, wherein the step of communicating information relating to the third association comprises automatically generating and sending an electronic mail message to an email address associated with the fourth logical management level of the hierarchy.

25. The method of claim 24, wherein the email address is a group email address associated with a group of users at the fourth logical management level of the hierarchy.

26. The method of claim 24, wherein the fourth logical management level of the hierarchy is identified in the database solely by the email address.

27. The method of claim 23, wherein the information relating to the third association comprises at least a hyperlink to a server at which the database is maintained.

28. The method of claim 27, wherein the information relating to the third association further comprises a temporary password to access the server.

29. The method of claim 23, further comprising:
receiving, from a user at the fourth logical management level of the hierarchy, a user profile that includes at least one of an identity of the user, a company affiliation of the user, contact information for the user, and a permanent password for use in accessing the server; and storing the user profile in the database.

30. The method of claim 23, wherein the step of receiving an association of a first group of the plurality of tasks and a first group of the plurality of sites and a first group of the plurality of schedules with a fourth logical management level of the hierarchy comprises:
displaying a list of tasks and sites and schedules with entities functioning at the fourth logical management level of the hierarchy, the list of entities having been pre-established by the user at the first logical management level of the hierarchy; and
receiving, from the user at the third logical management level of the hierarchy the association of the first group of the plurality of tasks and the first group of the plurality of sites and the first group of the plurality of schedules with the fourth logical management level of the hierarchy.

31. The method of claim 1, wherein the list of entities functioning at the third logical management level of the hierarchy comprises a listing containing identities of the entities.

32. The method of claim 23, wherein the step of receiving an association of a first group of the plurality of tasks and the first group of the plurality of sites and the first group of the plurality of schedules with a fourth logical management level of the hierarchy comprises:
displaying a listing of the plurality of tasks, the listing of tasks having been pre-established by the user at the second logical management level of the hierarchy; and displaying a listing of the plurality of sites, the listing of sites having been pre-established by the user at the second logical management level of the hierarchy; and displaying a listing of the plurality of schedules, the listing of schedules having been pre-established by the user at the second logical management level of the hierarchy, and
receiving, from the user at the third logical management level of the hierarchy, selection of the first group of tasks from the listing of tasks and the first group of sites from the listing of sites and the first group of schedules from the listing of schedules to produce the association of the first group of the plurality of tasks, the first group of the plurality of sites from the listing of sites and the first group of schedules from the listing of schedules with the fourth logical management level of the hierarchy.

33. The method of claim 13, further comprising:
receiving, from a user at the fourth logical management level of the hierarchy, a fourth association of a first task of the first group of tasks at a first site of the first group of sites at a first schedule of the first group of schedules with a worker responsible for completing the first task of the first group of tasks at the first site of the first group of sites during the first group of schedules of the first group of schedules;
storing the fourth association in the database such that control of the fourth association requires at least one of the second set of database access permissions and the first set of database access permissions; and
responsive to storage of the fourth association in the database, automatically communicating information relating to the fourth association to the worker, the information at least notifying the worker that the fourth association has been made.

34. The method of claim 33, wherein the step of automatically communicating information relating to the fourth association comprises automatically generating and sending an electronic mail message to an email address associated with the worker.

35. The method of claim 34, wherein the worker is identified in the database solely by the email address.

36. The method of claim 33, wherein the information relating to the fourth association comprises at least a hyperlink to a server at which the database is maintained.

37. The method of claim 36, wherein the information relating to the fourth association further comprises a temporary password to access the server.

38. The method of claim 33, the method further comprising:
receiving, from the worker, a user profile that includes at least one of an identity of the worker, a company affiliation of the worker, contact information for the worker, and a permanent password for use in accessing the server; and storing the worker profile in the database.

39. The method of claim 33, wherein the user at the first logical management level of the hierarchy, the user at the second logical management level of the hierarchy, the user at the third logical management level of the hierarchy, the user at the fourth logical management level of the hierarchy and the worker are each a single individual.

40. The method of claim 33, wherein the user at the first logical management level of the hierarchy and the user at the second logical management level of the hierarchy are a single individual.

41. The method of claim 33, wherein the user at the second logical management level of the hierarchy and the user at the third logical management level of the hierarchy are a single individual.

42. The method of claim 33, wherein the user at the third logical management level of the hierarchy and the user at the fourth logical management level of the hierarchy are a single individual.

43. The method of claim 33, wherein the user at the fourth logical management level of the hierarchy and the worker are a single individual.

44. The method of claim 33, wherein the first logical management level of the hierarchy, the second logical management level of the hierarchy, the third logical management level of the hierarchy, the fourth logical management level of the hierarchy and the worker are directly engaged by a single entity.

45. The method of claim 33, wherein the third logical management level of the hierarchy, the fourth logical management level of the hierarchy and the worker are directly engaged by a different entity(s).

46. The method of claim 33 further comprising:
receiving, from the fourth logical management level of the hierarchy, a priority categorization for the worker in connection with performing the first task.

47. The method of claim 46, wherein the priority categorization includes is at least primary, secondary, tertiary and ordinary levels, wherein primary is a higher priority than secondary, secondary is a higher priority than tertiary, and tertiary is a higher priority than ordinary.

48. The method of claim 33, further comprising:
generating, responsive to input from the worker, a periodic report identifying activities performed by the worker in connection with performing the first task;
and storing the periodic report in the database.

49. The method of claim 48, wherein the step of generating the periodic report comprises:
receiving, from the worker, selection of at least one activity from a list of activities and at least one site from a list of sites associated with the first task, the list of activities having been pre-established by the user at the second logical management level of the hierarchy; and
receiving, from the worker, information identifying a first period of time during which the selected activity was performed.

50. The method of claim 49, wherein the system automatically populates to predefined review fields, within the worker's periodic report, detailed task-related information collected by a call-center agent detailing worker activities reported through a service-call dispatch function

51. The method of claim 49, further comprising functionality that permits the call-center agent-collected dispatch information to be populated within the worker's periodic report in association with the precise time period of the task-related information, as previously reported to dispatch

52. The method of claim 49, further comprising providing the worker a link to view original dispatch information detail

53. The method of claim 49, further comprising providing the worker a link to automatically transfer dispatch activity information into appropriate fields of the periodic report associated with the worker.

54. The method of claim 49, further comprising prohibiting entry of periodic report information relative to any subsequent time periods until the information identifying the first period of time has been populated into the periodic report pertaining to the worker.

55. The method of claim 49, further comprising permitting a supervisor of the worker to view information in the periodic report so as to verify information in the periodic report during an approval process.

56. The method of claim 49, further comprising providing the supervisor a link to view the original dispatch information detail.

57. The method of claim 49, wherein the period of time covered by the periodic report is defined by a start time and a stop time and the step of generating the periodic report further comprises:
responsive to receiving selection of an activity from the list of activities and the period of time during which the selected activity was performed, entering the selected activity and the period of time in the periodic report; and
causing the stop time of a previous period of time to automatically trigger commencement of a subsequent period of time for entry of a subsequently selected activity such that entries in the periodic report are contiguous in time.

58. The method of claim 48, wherein the worker is an individual, the method further comprising:
requiring approval of the periodic report from a supervisor of the worker prior to storing the periodic report in the database.

59. The method of claim 58, further comprising using the approved and stored periodic report to produce required business-related information.

60. The method of claim 58, further comprising generating and disseminating scheduled reports to specific users which include a listing of workers who have failed to submit their periodic reports according to a predetermined deadline.

61. The method of claim 58, further comprising generating and disseminating scheduled reports to specific users which include a listing of supervisors who have failed to review their worker's periodic reports according to a predetermined deadline.

62. The method of claim 58, wherein the step of generating the periodic report comprises:
displaying a list of activities associated with the first task, the list of activities having been pre-established by the user at the second logical management level of the hierarchy;
displaying an entry field that facilitates entry of text to identify any problem encountered during performance of an activity associated with the first task;
receiving, from the worker, an indication that text is to be entered in the entry field;

63. The method of claim 62, wherein the worker is an individual, the method further comprising:
responsive to receiving text in the entry field, reporting any problem identified by the text to a supervisor of the worker.

64. The method of claim 33, further comprising:
receiving, from the user at the second logical management level of the hierarchy, a checkpoint(s), or question, regarding the progress of completion of the first task; and at a specified time
receiving, from the call-center agent, responses to the checkpoint(s) from a pre-designated contact, the response(s) indicating the progress of completion of the first task to be sent to different lists of recipients based upon the answer.

65. The method of claim 64, wherein each of the checkpoints comprises a question that generally requires a “yes” or “no” answer.

66. The method of claim 64, further comprising:
automatically notifying a centralized call-center agent of each checkpoint, the centralized call-center agent being responsible for ensuring completion of all checkpoints.

67. The method of claim 1, further comprising
receiving, from a centralized call-center agent, information related to a service inquiry pertaining to a job of the first group of jobs;
displaying a list of workers to the centralized call-center agent;
receiving selection of a person or entity from the list of workers to attend to performing a task or tasks as requested in the service inquiry.

68. The method of claim 67, wherein each person or entity on the list of workers are associated with a respective priority category.

69. The method of claim 68, wherein the priority category is at least one of primary, secondary, tertiary and ordinary, wherein primary is a higher priority than secondary, secondary is a higher priority than tertiary, and tertiary is a higher priority than ordinary.

70. A method for managing workflow to facilitate completion of a plurality of service-related tasks, the method comprising:
receiving, from a user at a second logical management level of a hierarchy of logical management levels, an association of a worker to each of the plurality of service-related tasks to produce a first association, the first logical management level being associated with a first set of database access permissions that are broader than a second set of database access permissions associated with a second logical management level of the hierarchy, the association including a priority level for each worker associated with a particular task of the plurality of service-related tasks;
storing the first association in the database such that control of the first association requires the first set of database access permissions;
displaying the first association to a call-center agent responsible for real-time assignment of workers to perform the plurality of service-related tasks;
receiving, from the user at the fourth logical management level of the hierarchy, an association of a first task with a first worker that is responsible for completing the first task to produce a second association;
storing the second association in a database such that control of the association requires at least one of the first set of database access permissions and the second set of database access permissions; and
responsive to storage of the second association, automatically creating an entry in a periodic report to provide information as to tasks performed by the worker during a predetermined time period, the entry identifying the first task.

71. A server residing on a communication network accessible by a plurality of client devices, the server comprising:
a database;
an interface to the Internet, the interface permitting selective access to the database by, among others, the plurality of client devices;
a processing device coupled to the database and the interface; and
a computer readable storage device that has stored therein a computer program that, when executed by the processing device, performs the following functions:
receives, from a user at a first logical management level of an hierarchy of logical management levels, an association of a first group of a plurality of jobs with a second logical management level of the hierarchy to produce a first association, the first logical management level being associated with a first set of database access permissions that are broader than a second set of database access permissions associated with the second logical management level, the first group of jobs including a plurality of tasks;
stores the first association in a database such that control of the first association requires the first set of database access permissions; and
responsive to storage of the first association in the database, automatically communicates information relating to the first association to the second logical management level of the hierarchy, the information at least notifying the second logical management level of the hierarchy that the first association has been made.

72. A computer readable storage device that has stored therein a computer program that, when executed by a processing device, performs the following functions:
receives, from a user at a first logical management level of a hierarchy of logical management levels, an association of a first group of the plurality of jobs with a second logical management level of the hierarchy to produce a first association, the first logical management level being associated with a first set of database access permissions that are broader than a second set of database access permissions associated with the second logical management level, the first group of jobs including a plurality of tasks;
stores the first association in a database such that control of the first association requires the first set of database access permissions; and
responsive to storage of the first association in the database, automatically communicates information relating to the first association to the second logical management level of the hierarchy, the information at least notifying the second logical management level of the hierarchy that the first association has been made.
